(19) United States
(12) Patent Application Publication
(10) Pub. No.: US 2012/0153003 A1
(43) Pub. Date: Jun. 21, 2012

(54) FASTENER DRIVING TOOL AND METHOD FOR OPERATING A FASTENER DRIVING TOOL

(75) Inventor: Tilo DITTRICH, Feldkirch (AT)

(73) Assignee: Hilti Aktiengesellschaft, Schaan (LI)

(21) Appl. No.: 13/326,058

(22) Filed: Dec. 14, 2011

(30) Foreign Application Priority Data
Dec. 15, 2010 (DE) 10 2010 063 173.6

(51) Int. Cl. B25C 1/18; B25C 1/14

(52) U.S. Cl. 227/10; 173/1

(57) ABSTRACT

A fastener driving tool and method for driving fasteners into a substrate is disclosed. The tool includes a working piston that is capable of being moved abruptly translationally so as to drive a fastener, such as a stud or a nail. In order to further improve the handling and/or energy efficiency during operation of a fastener driving tool, the fastener driving tool includes an operating device that enables switching between a manual and an automatic output-power regulating mode.

This application claims the priority of German Patent Document No. 10 2010 063 173.6, filed Dec. 15, 2010, the disclosure of which is expressly incorporated by reference herein.

### BACKGROUND AND SUMMARY OF THE INVENTION

The invention relates to a fastener driving tool for driving fasteners into a substrate, having a working piston that is capable of being moved abruptly translationally so as to drive a fastener, such as a stud or a nail. The invention further relates to a method for operating such a fastener driving tool.

From German Patent Document DE 103 25 920 B4, a fastener driving tool is known that is capable of being driven via expandable gasses and has a piston guide in which a driving piston is mounted so as to be displaceable. A piston return device comprises an electric motor drive and at least one transmission device for transmitting a powered actuating force to the driving piston. From German Patent Document DE 199 62 695 B4, a portable, combustion-operated fastening tool is known that has a combustion chamber, the size of which is changeable by axial displacement of a front-side combustion chamber wall. From European Patent Document EP 1 277 548 B1, a fastener driving tool is known that comprises a driving-depth control mechanism.

The aim of the invention is to further improve the handling and/or energy efficiency during operation of a fastener driving tool.

This aim is achieved in a fastener driving tool for driving fasteners into a substrate, having a working piston that is capable of being moved abruptly translationally so as to drive a fastener, such as a stud or a nail, in such a way that the fastener driving tool comprises an operating device that enables switching between a manual and an automatic output-power regulating mode. In manual output-power regulating mode, the driving energy is preferably regulated by a user by the operating device. In automatic output-power regulating mode, the driving energy is preferably calculated and regulated by a control, in particular electronic, on the basis of information about previous driving operations.

The fastener driving tool according to the invention is preferably gas-operated. The gas can be taken, for example, from a gas cartridge that is arranged in the fastener driving tool. The gas is mixed with air in a combustion chamber in the fastener driving tool. The air and gas form an ignitable mixture that expands abruptly so as to drive the working piston. A respective desired amount of gas is preferably metered into the combustion chamber for every driving operation according to volume or time by a metering valve. Particularly preferably, the driving energy is regulated by the metered amount of gas and/or by the optionally changeable volume of the combustion chamber.

The working piston may alternatively and with the aid of an intermediate storage device which may comprise for example a spring, be driven electrically. According to an essential aspect of the invention, the user is provided with a fastener driving tool that gives the user control over the optimization objective of the automatic system. The user or operator of the fastener driving tool is enabled in a simple manner to adjust to different demands of a fastening operation. In particular, the setting can be regulated for no nail protrusion or for a desired nail protrusion.

A preferred embodiment of the fastener driving tool is characterized in that the operating device comprises at least one operating element, by actuation and/or adjustment of which the movement of the working piston in automatic output-power regulating mode is interrupted in such a way when driving a fastener that the fastener protrudes from the substrate by a specified distance or is sunk into the substrate. The automatic output-power regulation ensures that a uniform nail protrusion can be ensured even when the substrate hardness varies. The automatic system prevents undesirable overloads of the fastener driving tool.

Another preferred embodiment of the fastener driving tool is characterized in that the distance by which the fastener protrudes from the substrate is adjustable continuously in automatic output-power regulating mode. The operating device may comprise a scale for this purpose on which the desired nail protrusion can be set.

Another preferred embodiment of the fastener driving tool is characterized in that the operating device comprises at least one operating element, by actuation and/or adjustment of which the piston energy supplied to the working piston when driving a fastener, and/or the piston forward stroke of the working piston can be adjusted continuously in manual output-power regulating mode. Piston forward stroke is understood to mean, for example, the distance traveled by the working piston between emerging from a fastener guide and impacting on a brake and/or buffer element. The piston forward stroke substantially determines how far a fastener, in particular a nail, is driven into the substrate. At reduced piston forward stroke, the working piston is slowed down prematurely and the fastener or the nail is driven less deeply into the substrate.

Another preferred embodiment of the fastener driving tool is characterized in that the fastener driving tool comprises an indicator device that displays output-power information in manual and/or automatic output-power regulating mode. With the aid of the indicator device, the user or operator of the fastener driving tool is informed, for example, whether the tool is at a controlled, optimal operating point, or whether the fastener driving tool is currently readjusting for over-power or under-power, in particular when the fastener driving tool is currently in automatic output-power regulating mode.

In a method for operating the aforedescribed fastener driving tool, the aforestated problem is alternatively or additionally solved in such a way that the fastener driving tool is switched between the manual and the automatic output-power regulating mode according to the demand. This makes it possible in a simple manner for the user or operator of the fastener driving tool to respond to a variety of very different fastening needs. An overload of the fastener during a desired fastening task is automatically prevented in this arrangement.

A preferred embodiment of the method is characterized in that actuation and/or adjustment of the operating device in automatic power output regulating mode interrupts the movement of the working piston in such a way when driving a fastener that the fastener either protrudes from the substrate by a specified distance or is sunk into the substrate. The distance by which the fastener protrudes from the substrate is preferably adjustable continuously in automatic output-power regulating mode.

Another preferred embodiment of the method is characterized in that the piston energy supplied to the working piston when driving a fastener, and/or the piston forward stroke of the working piston is/are adjusted continuously by actuation and/or adjustment of the operating device in manual output-power regulating mode. Piston forward stroke is understood to mean, for example, the distance traveled by the working piston between emerging from a fastener guide and impacting on a brake and/or buffer element.

Another preferred embodiment of the method is characterized in that in manual and/or automatic output-power regulating mode, output-power information is indicated on the fastener driving tool. This enables the user or operator to be warned when the tool load is too high or the driving energy is too low. In automatic output-power regulating mode, information about the control state of the automatic system is indicated to the user or operator.

Another preferred embodiment of the method is characterized in that an approximate target energy for driving the fastener is determined on the basis of the actuation and/or adjustment of the operating device and/or an evaluation of previous driving operations, optionally factoring in tool parameters and/or ambient parameters. When calculating the target energy, it is factored in, for example, whether the fastener and/or nail was driven in with too much or too little energy (over-energy or under-energy) during previous fastening operations. The over-energy or under-energy can be determined by measuring a front-end piston return point or by a load sensor provided on a buffer device.

The load history is preferably stored over up to six fastening operations. The load of the most recent fastening operation has the highest weighting. The longer ago the load occurred, the lower the weighting is of that load in determining the target energy.

Further advantages, features and details of the invention will become apparent from the following description, in which various embodiments are described in detail with reference to the drawings.

### BRIEF DESCRIPTION OF THE DRAWINGS

FIG. 1 shows a simplified illustration of a fastener driving tool according to the invention in a sectional view, with an operating device; and

FIG. 2 shows an enlarged illustration of the operating device of the fastener driving tool of FIG. 1.

### DETAILED DESCRIPTION OF THE DRAWINGS

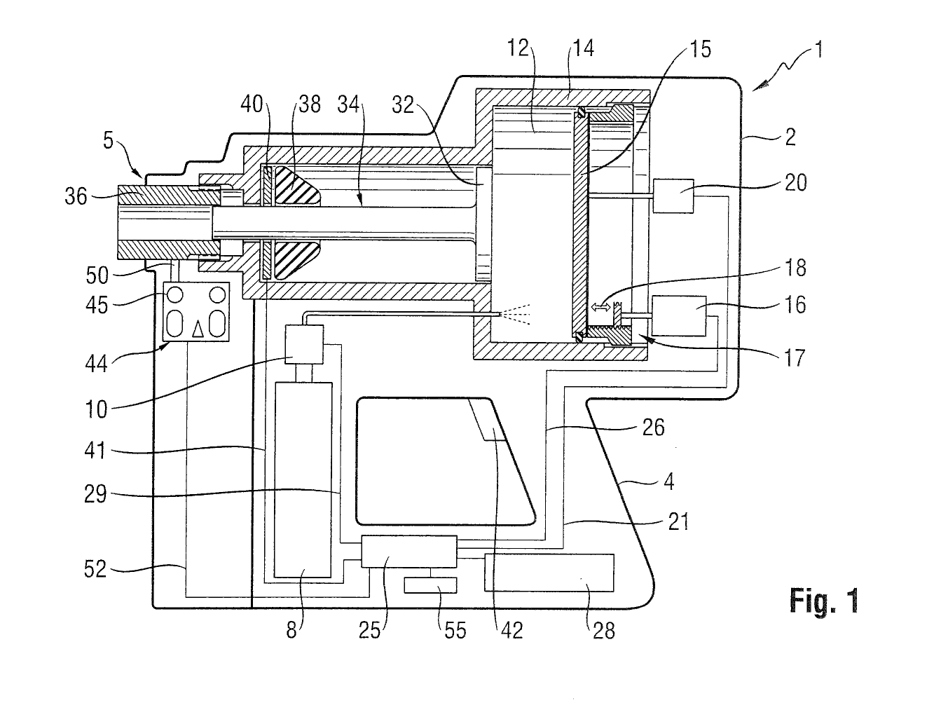

In FIG. 1, a fastener driving tool 1 according to the invention having a housing 2 is depicted greatly simplified in a longitudinal section. The housing 2 comprises a handle 4, by which the fastener driving tool 1 is capable of being grasped for driving a fastener that exits from the fastener driving tool 1 at a muzzle end 5 and is capable of being driven into a substrate.

The energy required to drive the fastener into the substrate is provided, for example, in a gas cartridge 8 in the interior of the fastener driving tool 1. The gas cartridge 8 is capable of being connected by an adjustable or controllable throttle valve 10 to a combustion chamber 12. In the combustion chamber 12, gas from the gas cartridge 8 is mixed with air to form a combustible mixture, which is ignited in order to drive a fastener, such as a stud or a nail, into the substrate.

The combustion chamber 12 is encompassed in the interior of the housing 2 by a cylinder 14. On a rear side of the cylinder 14, the combustion chamber 12 is closed off by an adjustable combustion chamber wall 15. The combustion chamber wall 15 can be adjusted with the aid of an electric motor 16 by an actuating gear mechanism 17, as indicated by a double arrow 18. By adjusting the combustion chamber wall 15 in the direction of the double arrow 18, the size of the combustion chamber can be varied in a simple manner.

State parameters in the combustion chamber 12 and/or the position of the adjustable combustion chamber wall 15 can be measured with the aid of a sensor device 20. The sensor device 20 is connected by a sensor line 21 to an electronic control 25. The electronic control 25 is connected in control relationship by a control line 26 to the electric motor 16. The electronic control 25 is supplied with electric energy from an accumulator 28, for example a battery. The electronic control 25 is connected in control relationship by a further control line 29 to the throttle valve 10.

The combustion chamber 12 is closed off on the side thereof opposite the adjustable combustion chamber wall 15 by a piston bottom 32 of a working piston 34. The working piston 34 is guided at the end thereof opposite the piston bottom 32 in a guide bush 36. The working piston 34 extends through a buffer device 38. The movement of the working piston 34 when driving a fastener is slowed down by the buffer device 38. The buffer device 38 has a further sensor device 40 associated therewith that is connected by a sensor line 41 to the electronic control 25.

Driving a fastener is triggered by a trigger 42 which is capable of being actuated on the handle 4, for example with the index finger. In addition to the trigger 42, the fastener driving tool 1 according to the invention comprises an operating device 44 having an operating element 45. The operating device 44 has a sensor device 50 associated therewith. The sensor device 50 is additionally associated with the guide bush 36. The operating device 44 is connected in control relationship by a control line 52 to the electronic control 25.

In addition to the trigger 42 and the operating device 44, the fastener driving tool 1 according to the invention comprises an indicator device 55 for indicating output-power information during operation of the fastener driving tool 1. The indicator device 55 is connected to the electronic control 25 and comprises, for example, a display whereby the information can be indicated alphanumerically. Alternatively or additionally, the indicator device 55 may have a color display.

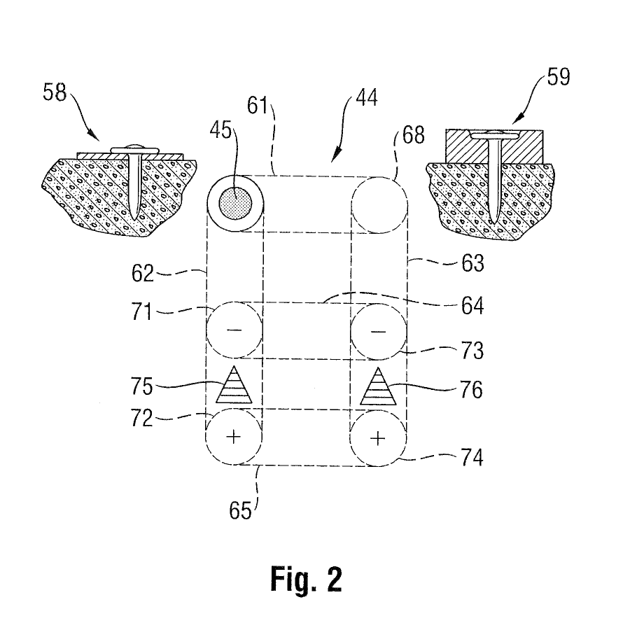

In FIG. 2, outlined in a broken-out section 59, a fastener is driven into the substrate in such a way that a head of the fastener is completely sunk into the component fastened. In a further broken-out section 58, a fastener is shown, the head of which still protrudes from the component fastened. The distance by which the head protrudes from the substrate is called also protrusion or stand-off.

In the field, different substrates and different fasteners require different driving energies. The greater the strength of the substrate, the more the driving energy demand increases. Moreover, the fastening application creates varying demands for nail protrusion or nail stand-off. When fastening steel rails to concrete, for example, a nail will protrude relative to the rail. When fastening wood, on the other hand, it may be required that the nail head be sunk into the wood.

In the operating device 44, the various setting options are outlined in FIG. 2 in the form of dashed elongated holes 61 to 65. The elongated hole 61 corresponds to an automatic output-power regulating mode. Elongated holes 64 and 65 correspond to a manual output-power regulating mode. Elongated holes 62 and 63 indicate that the user can switch between manual and automatic output-power regulating mode.

In FIG. 2 the operating element 45 is in a mode in which the fastener is sunk into the substrate. A dashed circle 68 indicates a second position of the operating element in automatic output-power regulating mode. When the operating element 45 is arranged in the second switching position 68, the fastener is not sunk but protrudes from the substrate by a certain protrusion, as outlined at 58.

In automatic output-power regulating mode, the operating element 45 may be adjusted continuously between mode 59 (sunk) and mode 58 (protruding). In lieu of a continuously variable adjustment, the operating device 44 may have two fixed settings in automatic output-power regulating mode, for modes 58 and 59.

In manual output-power regulating mode 64, 65, minus and plus signs indicate that the user or operator of the fastener driving tool 1 can regulate the piston energy and the piston forward stroke separately, directly and continuously variable.

In manual output-power regulating mode, dashed circles 71 to 74 indicate different switching positions.

Respective triangles 75 and 76 indicate that an operating element or the operating element 45 is adjustable continuously between switching positions 71 and 72, or 73 and 74, respectively. In this arrangement the switching positions 71 and 73 correspond to a comparatively low combustion energy or driving power, as indicated by the minus, and switching positions 72 and 74 correspond to a comparatively high combustion energy or driving power, as indicated by the plus.

During operation of the fastener driving tool 1, in particular in automatic output-power regulating mode, an approximate determination or calculation of the required target energy is made with the aid of the electronic control 25 on the basis of the setting of the operating device 44, an evaluation of previous driving operations, and additional tool parameters and ambient parameters. When calculating the target energy, it is factored in, in particular, whether the fastener was driven with too much or too little energy (over-energy or under-energy) during previous driving operations.

The over-energy or under-energy can be determined by measuring a front-end piston return point or by the sensor device 40 provided on the buffer device 38. The load history preferably over up to six driving operations is stored in the electronic control 25. The most recent load on the buffer device 38 has the highest weighting. The longer ago the load on the buffer device 38 occurred, the lower the weighting is of this load in calculating the target energy.

If the over-energy reduction in the fastener driving tool is greater during operation than a specified threshold value, the target energy is reduced. If no over-energy reduction takes place in the buffer device 38, the target energy is increased by an amount of delta. The target energy is preferably selected such that the buffer device 38 is contacted lightly in the desired operating point.

The piston energy of the working piston 34 is regulated on the basis of the calculated target energy. In gas tools, the required combustion chamber volume and the required metered amount are determined. The combustion chamber volume is regulated with the aid of the adjustable combustion chamber wall 15. The required metered amount is regulated with the aid of the throttle valve 10.

The metered amount is determined by factoring in ambient conditions, such as ambient temperature and ambient air pressure of the selected combustion chamber volume, and further tool parameters, such as tool temperature, gas cartridge pressure, gas cartridge type and gas cartridge fill level. For the injection of the calculated amount of gas, the electronic control 25 opens the normally closed throttle valve 10 for a specified length of time. In the process, the calculated amount of gas streams from the gas cartridge 8 into the combustion chamber 12.

By the indicator device 55 outlined in FIG. 1, the user or operator of the fastener driving tool 1 is informed during operation whether the fastener driving tool 1 is at a controlled, optimal operating point, or whether the fastener driving tool 1 is currently readjusting for over-power or under-power.

In manual output-power regulating mode the user or operator can regulate the piston forward stroke and piston energy separately. The indicator device 55 warns the user when over-energy or under-energy occurs. These warning situations are stored in the electronic control 25 over a relatively large number of driving operations, approximately fifty to one hundred driving operations. If, for example, a massive tool load of more than thirty percent over-energy occurs, the electronic control 25 switches to a safety mode, in which the over-energy is reduced to approximately twenty-five percent.

The user or operator can use the fastener driving tool according to the invention both for sinking fasteners, such as nails, into the substrate, as may be desirable when fastening wood to concrete, and for allowing fasteners, such as nails, to protrude, as is the case when fastening steel rails to concrete. In both cases the tool load can be reduced automatically.

Furthermore, the fastener driving tool 1 can ensure a uniform nail protrusion, even if the consistency of the substrate varies within certain limits. For this purpose, the fastener driving tool is operated at a certain over-energy that covers the range of variation of the substrate hardness. The fastener driving tool is designed in terms of the stability and robustness thereof for this slight over-energy. It is not possible to permanently damage the fastener driving tool 1 according to the invention by selecting an incorrect setting.

The automatic output-power regulating mode is of advantage in particular when fastening operations on similar substrates are performed for extended periods of time. Moreover, a very efficient utilization of the gas cartridge 8 is ensured in automatic output-power regulating mode. Accordingly, it is possible to perform a greater number of fastening operations per gas cartridge 8.

If situations occur in which the automatic energy system fails in automatic output-power regulating mode, for example in the case of greatly varying substrates, the manual output-power regulating mode presents the user with the option of regulating the tool behavior himself/herself by the tool energy and piston forward stroke.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A fastener driving tool for driving fasteners into a substrate, comprising:
a working piston; and
an operating device, wherein a control of an output-power deliverable to the working piston is switchable between a manual output-power regulating mode and an automatic output-power regulating mode via the operating device.

2. The fastener driving tool according to claim 1, wherein in the automatic output-power regulating mode a movement of the working piston is interruptible such that a fastener driven by the working piston either protrudes from the substrate by a specified distance or is sunk into the substrate.

3. The fastener driving tool according to claim 2, wherein the specified distance is adjustable continuously.

4. The fastener driving tool according to claim 1, wherein in the manual output-power regulating mode a piston energy supplied to the working piston and/or a piston forward stroke of the working piston is adjustable continuously.

5. The fastener driving tool according to claim 1, further comprising an indicator device, wherein output-power information is displayable on the indicator device in the manual and/or the automatic output-power regulating mode.

6. A method for operating a fastener driving tool, comprising the steps of:
switching the fastener driving tool to a manual output-power regulating mode or an automatic output-power regulating mode via an operating device.

7. The method according to claim 6, wherein in the automatic output-power regulating mode a movement of a working piston is interruptible such that a fastener driven by the working piston either protrudes from a substrate by a specified distance or is sunk into the substrate.

8. The method according to claim 6, wherein in the manual output-power regulating mode a piston energy supplied to a working piston and/or a piston forward stroke of the working piston is adjustable continuously.

9. The method according to claim 6, wherein in the manual and/or the automatic output-power regulating mode, output-power information is indicated on the fastener driving tool.

10. The method according to claim 6, further comprising the step of determining an approximate target energy for driving the fastener on a basis of an actuation and/or an adjustment of an operating device and/or an evaluation of previous driving operations, and/or tool parameters and/or ambient parameters.
